(19) United States
(12) Patent Application Publication
(10) Pub. No.: US 2005/0031109 A1
(43) Pub. Date: Feb. 10, 2005

(54) Group communication system

(76) Inventors: Christopher Lawrence Fernandez, Aurora, IL (US); Donna Michaels Sand, Redmond, WA (US)

Correspondence Address: Werner Ulrich, 434 Maple Street, Glen Ellyn, IL, 60137, US

(21) Appl. No.: 10/634,562

(22) Filed: Aug. 5, 2003

(51) Int. Cl. H04M 3/42; H04Q 11/00; H04L 12/16

(52) U.S. Cl. 379/202.01; 370/260

(57) ABSTRACT

A method and apparatus for establishing connections among members of telecommunications connections among members of a group of users. The group is identified in a setup request and a database is used to translate between the identity of the group and the identity of the members of the group. Connections are then established between a media duplicator and the individual members of the group. The media duplicator receives signals from all members of the group, combines them according to an appropriate algorithm, and transmits the combined signal to all members of the group. Advantageously, this arrangement allows frequently used group conferences to be established with a minimum of effort by the conferees.

### TECHNICAL FIELD

This invention relates to arrangements for communicating among groups of telecommunications users.

### BACKGROUND OF THE INVENTION

In the field of telephony, full duplex conference connections are made possible through the use of a conference bridge to which all the conferees are connected. Conferences must be established through the offices of an operator. In the case of a meet me conference, all conferees call a common number which has been assigned to the conference bridge and can then be attached.

The service of speed dialing allows an individual telephone customer to dial two or three numbers in order to reach one of a group of pre-assigned telephone numbers.

Programmed speed dialing, available on wireless or intelligent land based stations, similarly allows a connection to be established in response to the operation of one or two keys, soft or hard. Both speed dialing and programmed speed dialing establish full duplex connections.

Half duplex services are currently commercially available.

### SUMMARY OF THE INVENTION

Applicants have carefully studied all of these arrangements and have concluded that what is missing is an arrangement for connections among all available members of a predefined group in response to the operation of a single soft button for identifying the group. The group can be members of a family, a work group, or a temporary work team.

In accordance with Applicants' invention, a server connected to a telecommunications network has access to or contains a database for identifying the members of each group defined for the network. The identification of each member is a telephone number or a web address. The connections can be made over the public switched telephone network or by voice over internet (VOIP) channels. In response to a request for a group connection, the server consults the database, identifies the members of the group, and transmits signals to the network requesting a connection to a media duplicator. The media duplicator receives digital signals representing voice signals from each of the connected parties and selects among or processes these signals for transmission to the various members of the group.

For full duplex connections, the selection algorithm can be a simple conference arrangement in which signals from all speakers are added and transmitted to everyone, or can be a transmission of signals from the loudest speaker to all conferees. For calls where speaker priority is a need, half duplex connections will be established using the selection algorithm based on priority, i.e., connect the highest priority speaker, possibly with arrangements for changing priority during the call); the speaker who has the floor optionally including facilities for requesting the floor and for queuing such requests; the facilities can include interrupt arrangements by priority or by operation of a soft or hard button.

In accordance with one feature of the invention, a record of the conference can be stored for any or some selected group of absent members.

### BRIEF DESCRIPTION OF THE DRAWING(S)

FIG. 1 is a block diagram illustrating the operation of Applicants' invention; and

FIG. 2 is a flow diagram illustrating the operation of Applicants' invention.

### DETAILED DESCRIPTION

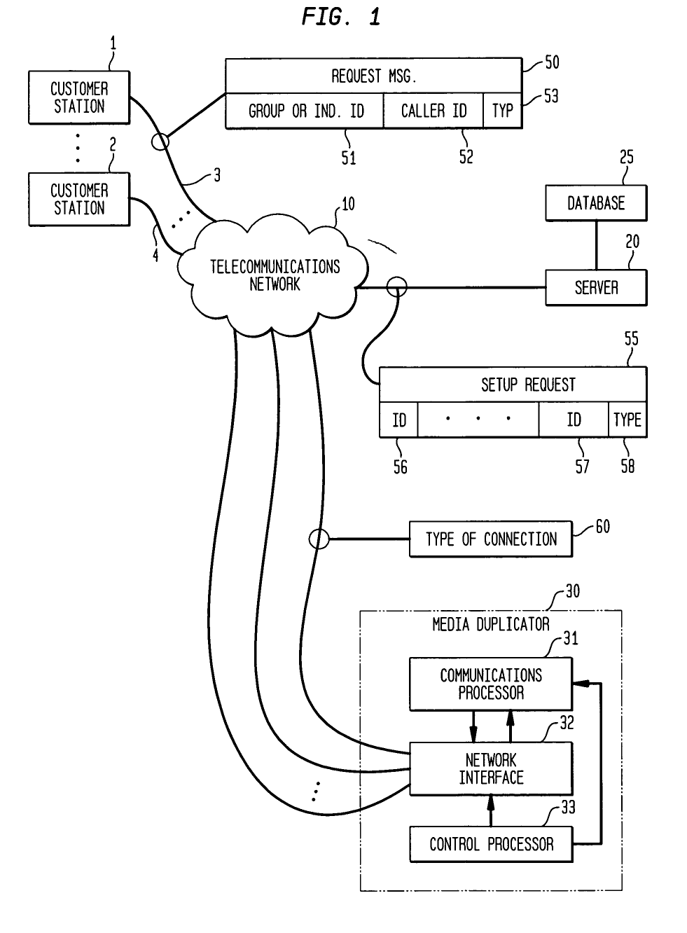

FIG. 1 is a block diagram illustrating Applicants' invention. A group of customer stations 1, . . . , 2 are connected to a telecommunications network 10 by links 3, . . . , 4. Also connected to the telecommunications network is a server 20 and its database 25 for interpreting a request containing the identity of a caller and the specified group or individual. Also shown is a media duplicator 30 for accepting communications inputs from all members of the group and transmitting outputs to all the members. The media duplicator, server, and database are shown as separate from the telecommunications network to clarify the operation of Applicants' invention. In an actual implementation, one or more of these units can be integrated into the telecommunications network.

A customer station makes a request by sending a request message 50 containing an identity of the group or individual 51 and the identity of the caller 52, and the type 53 of connection (full duplex or half duplex) requested. In alternate implementations, the identity of the caller can be inserted by the telecommunications network. The group or individual identity can be specified by the operation of a soft button, i.e., a click on a computer display. A telecommunications network 10 passes these messages to the server 20. The server 20 then consults database 25 to fetch the identities of the members of the group or of an individual (which may be known to the originator by a nickname). Server 20 then sends a conference setup request message to telecommunications network 10 including the identities of all of the members of the group 56, . . . , 57 and the type of connection being requested 58. In response to this message 55 the network seizes a media duplicator 30 and establishes connections between the network interface 32 of the media duplicator and the various customer stations 1, . . . , 2 of the group. Alternatively, the server contacts the media duplicator directly, without communication through the telecommunications network. The media duplicator contains a communications processor for processing individual inputs to the network interface 32 in order to generate the individual outputs from that network interface. The media duplicator is controlled by a control processor 33 which receives information as to the type of connection conveyed in message 60 from the telecommunications network and uses this information to control the communications processor. During the call, individual messages concerning the type of connection can be sent by individual customer stations to the control processor.

The telecommunications network is a combination of the Internet, the public switched telephone network, the public wireless network, and available broadband networks. The connections which can be established can be simple voice connections or broadband connections. The customer stations can be connected to the network through land based telephone facilities using conventional speech transmission or voice over Internet protocol, or through wireless facilities.

The media duplicator network interface can establish full duplex or half duplex connections.

For either of the above arrangements, an interrupt arrangement can be superimposed wherein either by priority or by the operation of a soft button one member of the group can seize the floor.

Arrangements can also be made to record the group conference for any members who were unable to join the group.

The above discussion has been limited to group voice arrangements. For the case of data or video, the arrangement would generally be one in which the transmitter sends to all other members of the group, i.e., essentially a half duplex type of operation. However, the arrangements for seizing the floor and priority interrupts can be usefully applied to these arrangements to allow other members of the group to transmit their own data or video messages.

Another use of video group calling would be to support full duplex video group calling. The video input from each member would not mixed together, but each video input would be sent to each member of the group and be available in a split-screen view on the member's terminal. The user terminal equipment may also provide the option to display input from one or a subset of the inputs received for better viewing, rather than display of each group member's video input. The displayed video input(s) could be changed by the end user via control of their user equipment display.

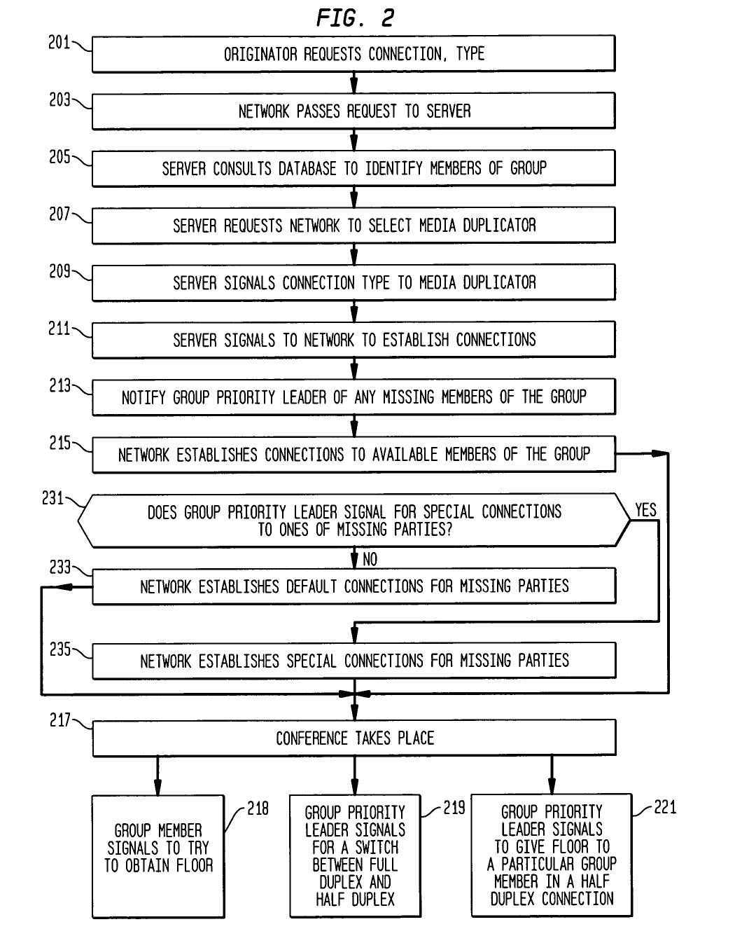

FIG. 2 is a flow diagram illustrating the operation of Applicants' invention. An originator requests a connection specifying the group identity and type of connection (full duplex or half duplex, data or voice) (action block 201). These messages are sent (action block 203) to the server and the server consults the database to identify members of the group (action block 205). The server then requests the network to select a media duplicator (action block 207). The server signals to the media duplicator about the type of connection being requested (action block 209). The server signals to the network to establish the connections between the media duplicator and the individual members of the group (action block 211). If the network discovers that any member of the group is not available (either busy or does not answer) then a group priority leader is notified (action block 213). The server normally contains a default attribute for the treatment of any member of the group that is missing (for example, simply to ignore this member, to connect a pre-specified alternate, or to make a connection to voice mail to record the results of the conference). The network establishes connections between the media duplicator and the available or default parties (action block 215).

Test 231 is used to determine if the group priority leader or the call originator signals for special connections to ones of the missing parties. If not, then the network establishes the default connections (action block 233) and continues to action block 217. If the group priority signals for special connections then the network establishes the special connections on behalf of the missing parties (action block 235) and processing continues with action block 217. In action block 217, the conference takes place. Outputs from action block 217 include for the case of a half duplex connection signals from individual group members to the media duplicator to record a request for an opportunity to seize the floor (action block 218). In response to this request, the media duplicator alters the internal connection to be responsive to such requests. In addition, the group priority leader can signal at any time for a switch between full duplex and half duplex conference (action block 219) or the group priority leader can signal for giving the floor to or taking the floor from any particular member of the group in a half duplex conference configuration (action block 221).

The above is one preferred embodiment of Applicants' invention. Other embodiments will be apparent to those of ordinary skill in the art without departing from the scope of the invention. The invention is only limited by the attached claims.

1. A method of establishing a telecommunications group connection comprising the steps of:
responsive to the operation of an indicator, transmitting a request to a telecommunications network to establish a duplex group connection among the members of a group identified in said message;
in a database, translating between the identification of the group and the identifications of the members of the group;
in said network, establishing connections between members of said group and a media duplicator for receiving input signals from members of the group and for transmitting group output signals to members of the group.

2. The method of claim 1 wherein said group connection is a voice group connection wherein members of the group can hear a plurality of other talking members.

3. The method of claim 1 wherein said group connection is a video group connection wherein members of the group can see a plurality of other members.

4. The method of claim 1 wherein a connection to a storage system is substituted for a connection to an absent member of the group.

5. The method of claim 1 wherein a connection to a pre-assigned alternate member is substituted for a connection to an absent member of the group.

6. The method of claim 1 wherein a leader of said group designates treatment of connections to absent members of said group.

7. The method of claim 1 wherein said indicator is a soft button.

8. The method of claim 1 wherein said indicator is a telephone alphanumeric key.

9. The method of claim 1 further comprising the step of:
a specific member of said group signaling said media duplicator to request a half duplex connection from said specific member's station to other members of the group.

10. The method of claim 1 wherein the step of transmitting a request comprises the steps of:
transmitting said request to a server; and
transmitting a series of set-up requests from said server to said telecommunications network.

11. The method of claim 1 wherein said group connection is a half duplex connection.

12. The method of claim 1 wherein said group connection is a full duplex connection.

13. Apparatus establishing a telecommunications group connection comprising:
means, responsive to the operation of an indicator, for transmitting a request to a telecommunications network to establish a group connection among the members of a group identified in said message;
in a database, means for translating between the identification of the group and the identifications of the members of the group;
in said network, means for establishing connections between members of said group and a media duplicator for receiving input signals from members of the group and for transmitting group output signals to members of the group.

14. The apparatus of claim 13 wherein said group connection is a voice group connection wherein members of the group can hear a plurality of other talking members.

15. The apparatus of claim 13 wherein said group connection is a video group connection wherein members of the group can see a plurality of other members.

16. The apparatus of claim 13 wherein said indicator is a soft button.

17. The method of claim 13 wherein said indicator is a telephone alphanumeric key.

18. The apparatus of claim 13 wherein the means for transmitting a request comprises:
means for transmitting said request to a server; and
means for transmitting a series of set-up requests from said server to said telecommunications network.

19. The apparatus of claim 13 wherein said group connection is a half duplex connection.

20. The apparatus of claim 13 wherein said group connection is a full duplex connection.
